(19) United States
(12) Patent Application Publication
(10) Pub. No.: US 2015/0215055 A1
(43) Pub. Date: Jul. 30, 2015

(54) WIRELESS APPARATUS AND CONTROLLER

(71) Applicant: Kabushiki Kaisha Toshiba, Tokyo (JP)

(72) Inventor: Akihito Okumura, Kodaira-shi (JP)

(21) Appl. No.: 14/598,753

(22) Filed: Jan. 16, 2015

Related U.S. Application Data
(60) Provisional application No. 61/932,670, filed on Jan. 28, 2014.

(51) Int. Cl. H04B 17/27; H04W 4/04; H04W 4/00

(52) U.S. Cl. CPC H04B 17/27; H04W 4/008; H04W 4/04

(57) ABSTRACT

There is provided a wireless apparatus with its installation place settable by a controller, including: a receiver configured to receive the value of the set installation place from the controller; a memory configured to the value of the installation place; and a transmitter configured to the value of the installation place to a communication terminal.

### CROSS-REFERENCE TO RELATED APPLICATION(S)

This application claims priority from U.S. Provisional Patent Application No. 61/932,670 filed on Jan. 28, 2014, the entire contents of which are incorporated herein by reference.

### TECHNICAL FIELD

The invention relates to a wireless apparatus and a controller.

### BACKGROUND ART

Recently, with the enhanced power saving consciousness and introduction of the HEMS subsidy system, the number of apparatuses corresponding to the HEMS has been increased. The HEMS corresponding apparatuses respectively use Echonet lite. As the physical layer of Echonet lite, there can be used wired LAN, wireless LAN, Bluetooth or the like. In the case of the HEMS corresponding apparatus, multiple products of the same kind can also be installed in a home.

Until now, especially when multiple Bluetooth products of the same kind are installed in the vicinity, on the Bluetooth apparatus list, they are displayed by the same apparatus name, which makes it difficult to distinguish their respective installation places. It takes time and labor to establish pairing and connection with them while checking the installation places of the apparatuses and the Bluetooth addresses of the respective apparatuses.

To solve this problem, in the prior art technology, there is known a method for setting priority order based on the radio wave intensity of Bluetooth and using it as a guide to the installation places. However, in the case of Bluetooth, the radio wave intensity does not always correspond to the distance between the apparatuses, which makes it difficult to specify the installation places of the apparatuses.

### BRIEF DESCRIPTION OF THE DRAWINGS

FIG. 1 is a perspective view of the appearance of an electronic apparatus of an embodiment.

FIG. 2 is a block diagram of an example of the structure of the electronic apparatus of the embodiment.

FIG. 3 is a hard system structure view of a mobile phone 10c which is an example of a communication terminal of the embodiment.

FIG. 4 is a hard system structure view of a wireless apparatus 10a which is an example of a communication terminal of the embodiment.

FIG. 5 is a sketch of an apparatus installed in a building and incorporating therein Echonet, or Echonet lite and Bluetooth.

FIG. 6 is a view of an example of the setting of installation locations in a controller of the embodiment.

FIGS. 7A and 7B are explanatory views of an example of Bluetooth apparatus retrieval results within a building.

FIG. 8 is a flow chart of communication between a controller and wireless apparatus, Bluetooth apparatus.

### MODE FOR CARRYING OUT THE INVENTION

Now, description is given below of an embodiment of the invention.

### First Embodiment

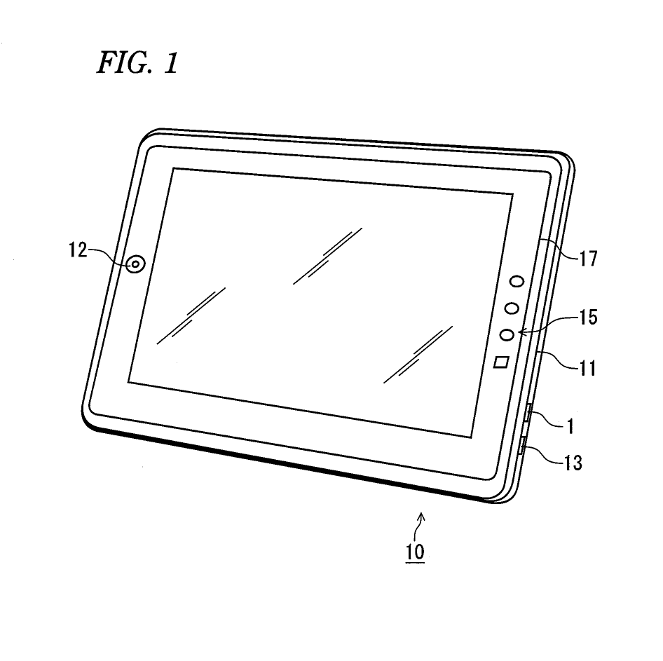

Description is given of a first embodiment with reference to FIGS. 1 to 8.

FIG. 1 is a perspective view of the appearance of an electronic apparatus according to an embodiment. This electronic apparatus is realized as, for example, a tablet type personal computer (PC) 10. The electronic apparatus is also realized as a smart phone, a PDA, a note book type PC and the like. As shown in FIG. 1, this computer 10 is, for example, a wall attachment (wall hanging) type including a computer main body 11 and a touch screen display 17.

The computer main body 11 has a thin box-shaped housing. The touch screen display 17 incorporates therein an LCD (liquid crystal display) 17A and a touch panel 17B. The touch panel 17B is arranged to cover the screen of the LCD 17A. The touch screen display 17 is mounted while it is superimposed on the upper surface of the computer main body 11. In the end portion surrounding the screen of the LCD 17A, there are arranged a camera module 12 and an operation button group 15. Here, the camera module 12 may also be disposed on the back surface of the computer main body 11 depending on a use form.

On the upper surface of the computer main body 11, there are arranged a power button for turning on/off the power source of the computer 10, a volume control button, a memory card slot and the like. On the lower surface the computer main body 11, there are arranged a speaker and the like. On the right side surface of the computer main body, there are disposed, for example, a USB connector 13 for connecting a USB cable and a USB device of the USB (universal serial bus) 2.0 standard, and an external display connecting terminal 1 corresponding to the HDMI (high-definition multimedia interface) standard, and the like. The external display connecting terminal 1 is used to output a digital video signal to an external display. Here, the camera module 12 may also be an external camera connected through the USB connector 13 or the like.

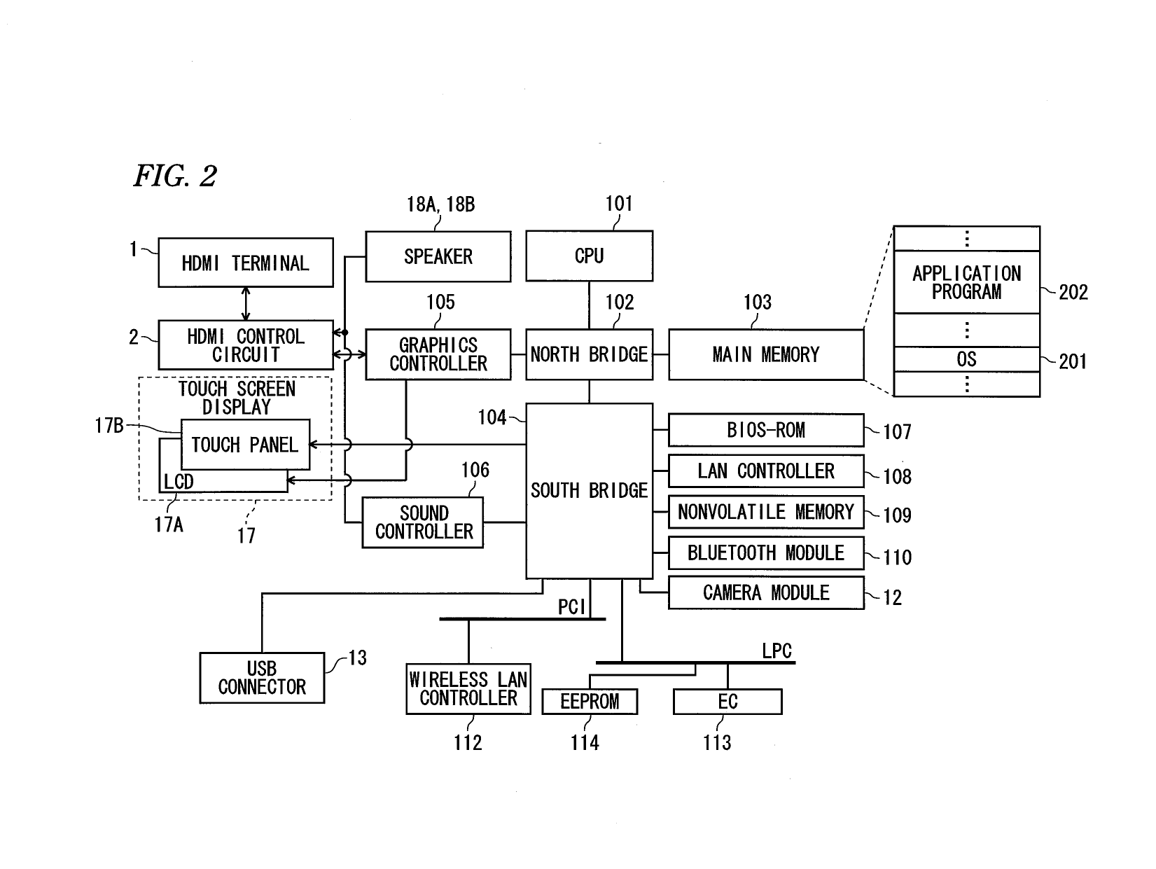

FIG. 2 is a diagram of the system structure of the computer 10.

The computer 10, as shown in FIG. 2, includes a CPU 101, a north bridge 102, a main memory 103, a south bridge 104, a graphics controller 105, a sound controller 106, a BIOS-ROM 107, a LAN controller 108, a hard disk drive (HDD) 109, a Bluetooth (registered trade mark) module 110, a camera module 12, a vibration module 14, a wireless LAN controller 112, an embedded controller (EC) 113, an EEPROM 114, an HDMI control circuit 2 and the like.

CPU 101 is a processor for controlling the operations of the respective interior composing parts of the computer 10. CPU 101 executes an operating system (OS) 201, various application programs 202 and the like which are loaded from HDD 109 to the main memory 103.

Also, CPU 101 also executes BIOS stored in BIOS-ROM 107. BIOS is a program for hardware control.

The north bridge 102 is a bridge device for connecting together the local bus of CPU 101 and south bridge 104. The north bridge 102 also incorporates therein a memory controller for access controlling the main memory 103. Also, the north bridge 102 has a function to execute communication with the graphics controller 105 through a serial bus of the PC1 EEXPRESS standard.

The graphics controller 105 is a display controller for controlling LCD 17A used as the display monitor of the computer 10. A display signal generated by the graphics controller 105 is sent to LCD 17A. LCD 17A displays a picture thereon according to the display signal.

The HDMI terminal 1 is the above-mentioned external display connecting terminal. The HDMI terminal 1 can transmit a non-compressed digital image signal and a digital audio signal through a single cable to an external display apparatus such as a TV set. The HDMI control circuit 2 is an interface for transmitting a digital video signal through the HDMI terminal 1 to an external display apparatus called a HDMI monitor.

The south bridge 104 is used to control devices arranged on a PCI (Peripheral Component Interconnect) bus and devices on an LPC (Low Pin Count) bus. Also, the south bridge 104 incorporates therein an IDE (Integrated Drive Electronics) controller for controlling HDD 109.

The south bridge 104 incorporates therein a UBS controller for controlling the touch panel 17B. The touch panel 17B is a pointing device for executing an input on the screen of the LCD 17A. A user, using the touch panel 17B, can operate a graphical user interface (GUI) and the like displayed on the screen of the LCD 17A. For example, the user, by touching a button displayed on the screen, can instruct the execution of a function corresponding to the button. Also, the USB controller executes, for example, communication with an external apparatus through a cable of the USB 2.0 standard connected to the USB connector 13.

Further, the south bridge 104 has a function to execute communication with the sound controller 106. The sound controller 106 is a sound source device for outputting audio data to be reproduced to speakers 18A, 18B. The LAN controller 108 is, for example, a wired communication device for executing wired communication of the IEEE 802.3 standard. The wireless LAN controller 112 is, for example, a wireless communication device for executing wireless communication of the IEEE 802.11g standard. The Bluetooth module 110 is a communication module for executing Bluetooth communication with an external apparatus.

EC 113 is a one-chip microcomputer including an embedded controller for power management. EC 113 has a function to turn on/off the power source of the computer 10 according to the operation of the power button by the user.

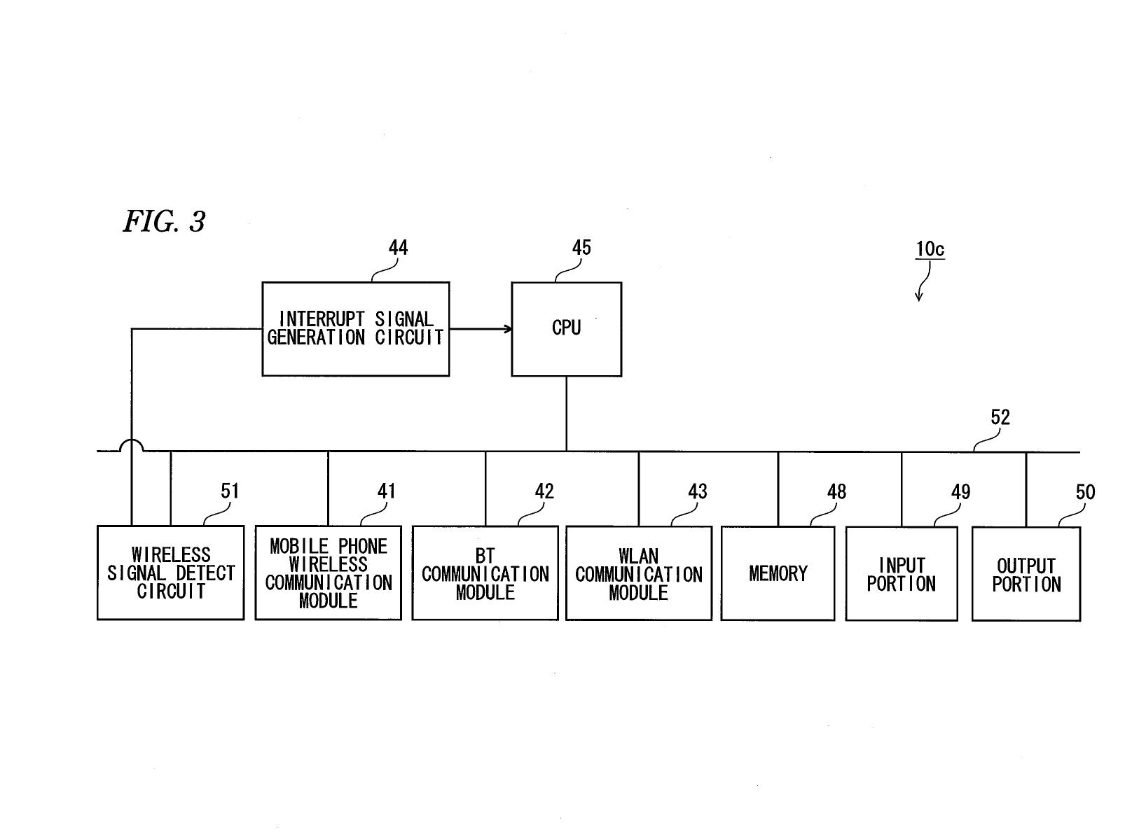

FIG. 3 is a hard system structure view of a mobile phone 10c which is an example of a communication terminal according to the embodiment.

In the mobile phone 10c of the embodiment, description is given mainly of a structure for realizing wireless communication with other communication terminal, while the specific description of a hard system structure provided normally in a mobile phone is omitted.

The mobile phone 10c includes a mobile phone wireless communication module 41, a Bluetooth communication module 42, a wireless LAN communication module 43, a CPU 45, a memory 48, an input portion 49, an output portion 50, and a wireless signal detect circuit 51. The respective parts of the mobile phone 10c are connected together by a bus 52.

The mobile phone wireless communication module 41 realizes transmission and reception of sounds and data with a base station. The mobile phone wireless communication module 41 includes an antenna and receives from space a wireless signal to be transmitted through a specific communication process system from a base station stored in a mobile communication network. Also, the mobile phone wireless communication module 41 radiates a specific wireless signal into space through the antenna in order to be able to execute wireless communication with the base station through the specific communication process system. The mobile phone wireless communication module 41, after implementing a specific processing on the signal received, outputs data to CPU 45 and also output a sound from a receiver serving as the output portion 50. Also, the mobile phone wireless communication module 41, after execution of a specific processing, transmits data output from CPU 45 and sounds collected by a microphone serving as the input portion 49.

The Bluetooth (BT) communication module 42 executes through an antenna wireless communication with other communication terminals existing in the vicinity (several m˜ten and several m) of the mobile phone 10c.

The wireless LAN (WLAN) communication module 43 executes through a built-in antenna (not shown) wireless LAN communication based on a specific standard such as the IEEE802.11a/b/g.

When executing wireless LAN communication (to be discussed later), only the WLAN communication module 43 may also be provided, and when implementing a synchronous processing using the Bluetooth communication, only the BT communication module 43 may also be provided. This also applies similarly in a wireless apparatus 10a (which is discussed later).

CPU (Central Processing Unit) 45 executes various processings according to programs stored in ROM (Read Only Memory) serving as the memory 48, or, according to various application programs and control programs including an operating system (OS) loaded from the ROM to a RAM (Random Access Memory). CPU 45 generates various control signals and supplies them to the respective parts to thereby control the mobile phone 10c totally. The RAM stores properly data necessary for CPU 45 to execute various processing. The memory 48 includes a flash memory element or an HDD (Hard Disc Drive) which is an electrically rewritable or erasable non-volatile memory.

The input portion 49 accepts an input through an input device such as an operation key type device or a touch panel type device and outputs this input signal to CPU 45. Also, in voice communication, it collects the voice of a user through a microphone. The output portion 50 outputs data constituted of characters and images according to an instruction from CPU 45. The output portion 50 is constituted of, for example, an LCD (Liquid Crystal Display), an organic EL (ElectroLuminescence) display, and an inorganic EL display. Also, in voice communication, it outputs the voice of a communicating partner through a receiver.

The wireless signal detect circuit 51 is a circuit which detects a wireless signal transmitted from a wireless apparatus 10a (other communication terminal) and having an amplitude modulation waveform. The wireless signal detect circuit 51 determines the kind of a signal according to the pattern and cycle of the magnitude of the time-axis power value of a signal received from the wireless apparatus 10a and, on detecting a specific signal contained in the received wireless signal, it outputs a specific control signal to an interrupt signal generation circuit 44. The interrupt signal generation circuit 44 generates an interrupt signal according to the signal output from the wireless signal detect circuit 51 and notifies CPU 45 of generation of an interrupt processing.

The wireless signal detect circuit 51 monitors this wireless signal with operation power lower than the operation power with which the WLAN communication module 43 and BT communication module 42 respectively serving as a local communication portion monitor a wireless signal transmitted from the wireless apparatus 10a. Here, the respective composing circuits of the wireless signal detect circuit 51 are structured by applying the conventional technology capable of realizing power saving stated in the document to be cited in the respective below-given descriptions of the circuits. However, the wireless signal detect circuit 51 is not limited to the structure stated in the below-cited document but may also have any structure so long as at least it can monitor the wireless signal with operation power lower than the operation power with which the WLAN communication module 43 and BT communication module 42 respectively serving as a local communication portion monitor a wireless signal transmitted from the wireless apparatus 10a.

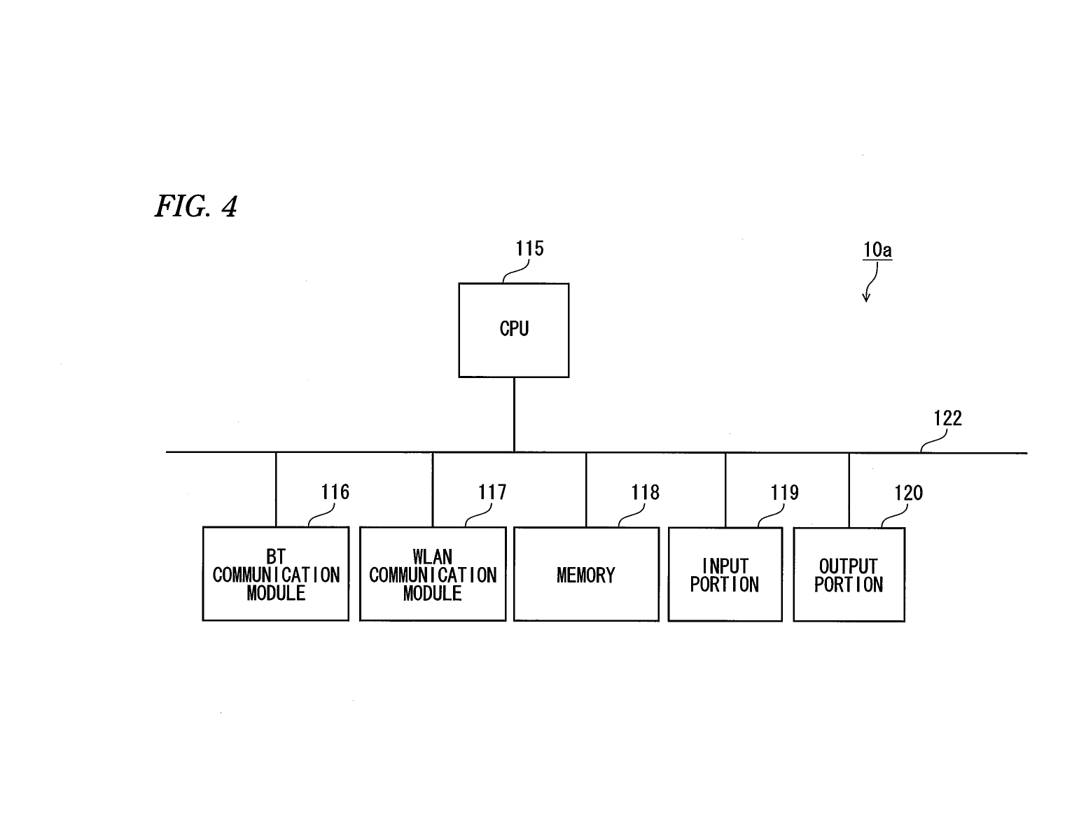

FIG. 4 is a hard system structure view of a wireless apparatus 10a which is an example of a communication terminal of the embodiment.

The wireless apparatus 10a includes a Bluetooth communication module 116, a wireless LAN communication module 117, a CPU 115, a memory 118, an input portion 119, and an output portion 120. The respective parts of the wireless apparatus 10a are connected together by a bus 122.

The Bluetooth (BT) communication module 116 executes wireless communication through a built-in antenna (not shown) with other communication terminals existing in the vicinity (several m˜ten and several m) of the wireless apparatus 10a.

The wireless LAN (WLAN) communication module 117 executes through a built-in antenna (not shown) wireless LAN communication based on a specific standard such as IEEE802.11a/b/g.

CPU (Central Processing Unit) 115 executes various processings according to programs stored in ROM (Read Only Memory) serving as a memory 118, or, according to various application programs and control programs including an operating system (OS) loaded from the ROM to a RAM (Random Access Memory). CPU 115 generates various control signals and supplies them to the respective parts to thereby control the wireless apparatus 10a totally. The RAM stores properly data and the like necessary for CPU 115 to execute various processings. Also, the memory 118 includes a flash memory element or an HDD (Hard Disc Drive) which is an electrically rewritable or erasable non-volatile memory.

The input portion 119 accepts an input through an input device such as a keyboard or a touch panel type device and outputs this input signal to CPU 115. The output portion 120 outputs data constituted of characters or images according to an instruction from CPU 115.

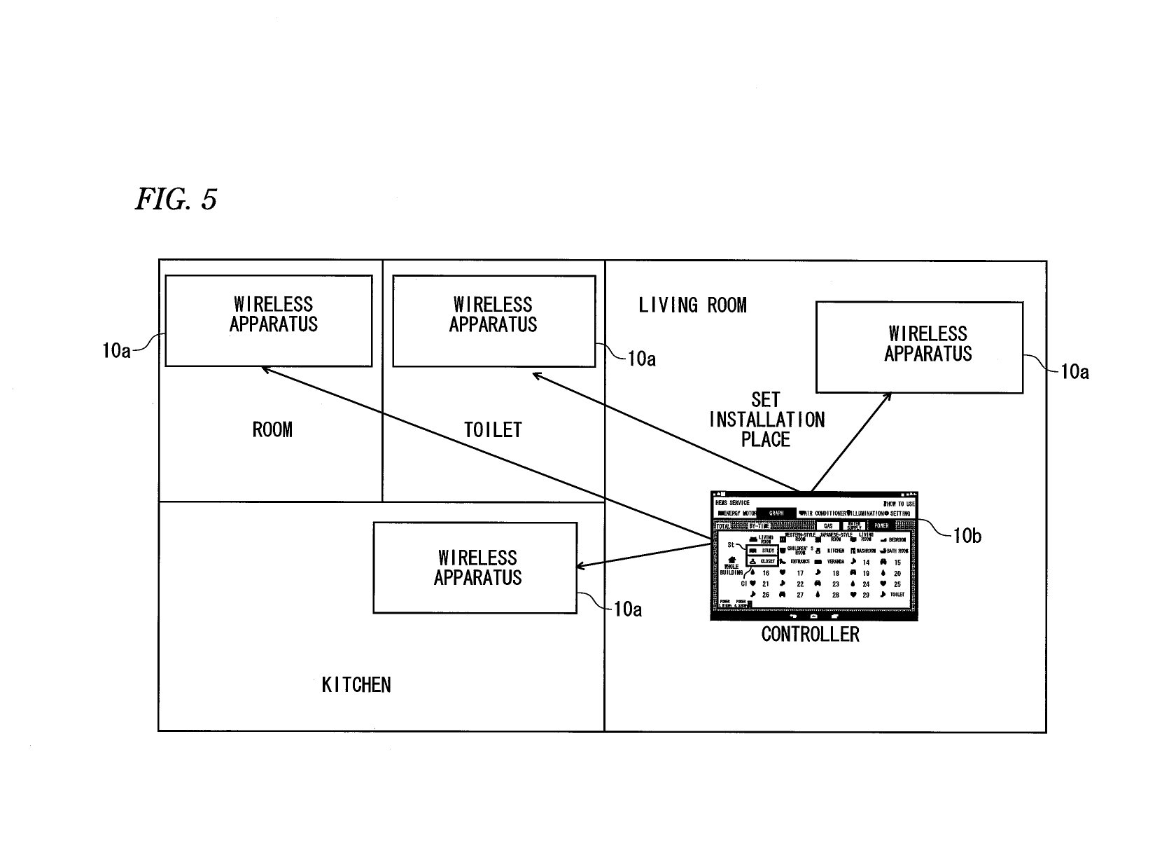

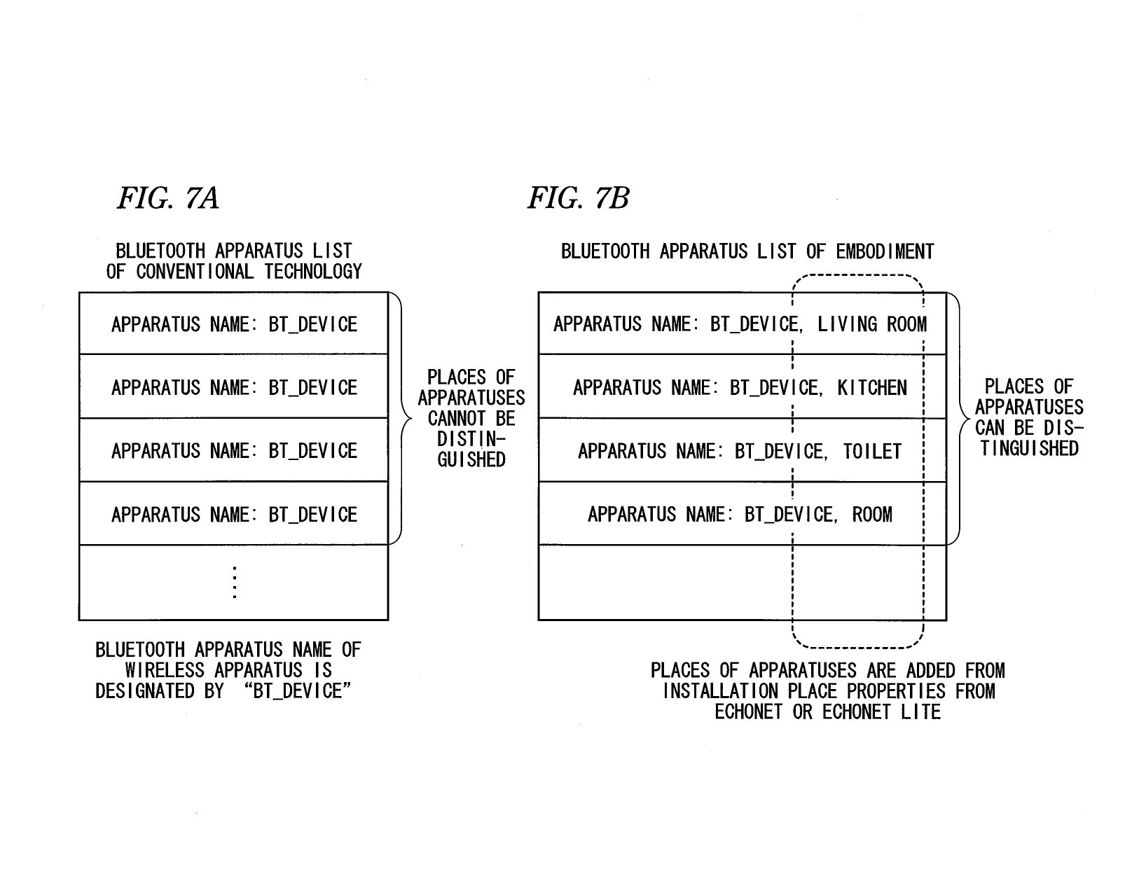

FIG. 5 is a sketch of an apparatus installed within a building and incorporating therein Echonet, or Echonet lite and Bluetooth. In this example, a controller 10b installed in a living room is wireless connected to wireless apparatuses 10a respectively installed in the living room, (a certain) room, a toilet and a kitchen and is capable of setting the installation places of these wireless apparatuses in such a manner as shown in FIGS. 7A and 7B. The controller 10b is structured as a function using the hardware of the computer 10, the respective operations of which are dictated below.

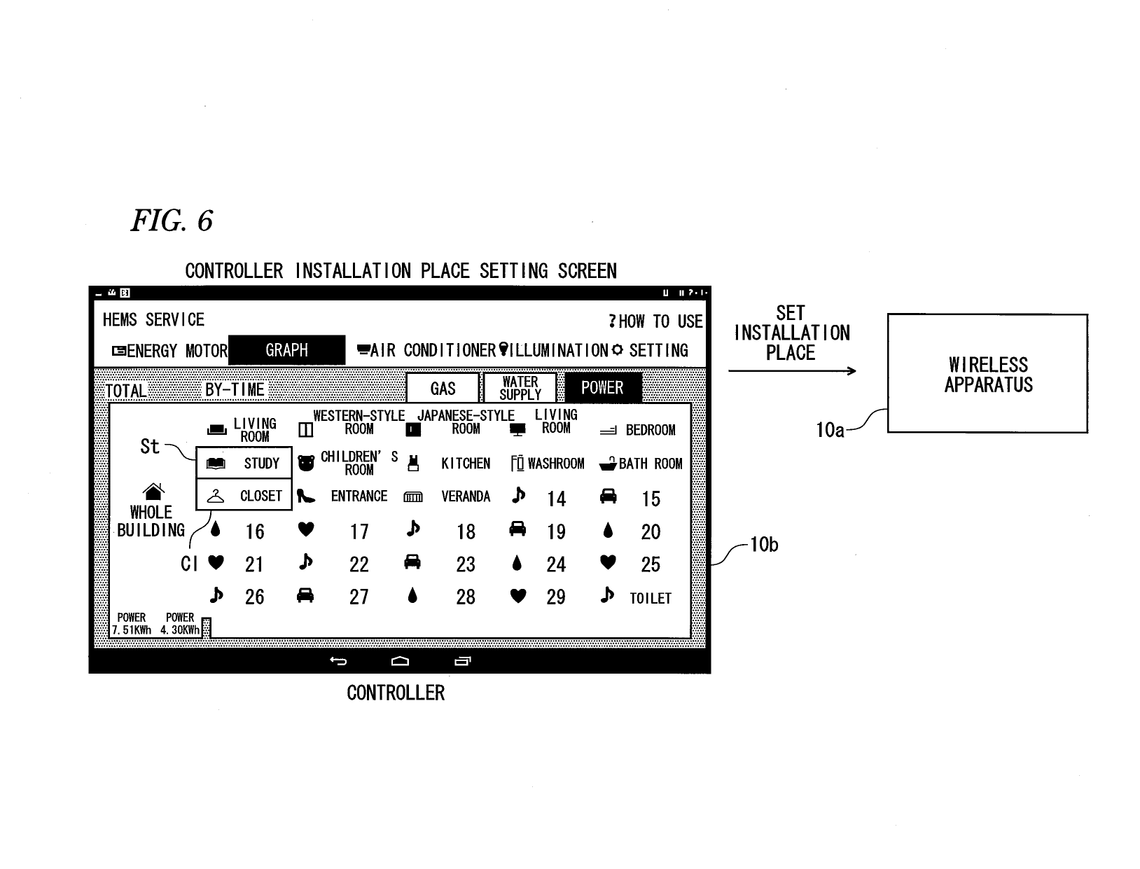

FIG. 6 is a view of an example of the installation places set by the controller of the embodiment. The wireless apparatus installation place setting screen of the controller 10b is structured such that a user can select, for example, a closet Cl and a study St and can set them as shown in FIGS. 7A and 7B.

In Echonet or Echonet Lite, an apparatus object super class is defined, while all of Echonet or Echonet Lite apparatuses succeed to this definition and incorporate it therein. The apparatus object super class includes a property called “an installation place” which must be essentially incorporated in the apparatus, while a value for representing the installation place can be set here.

That is, in the Echonet specification, as the installation place property, the relation between an installation place space name and an allotting bit is specified. When b7 of a free definition specification bit serving as MSB is 0 and an installation place code (b6-63) is 1011b, there is provided a closet property. On the other hand, in the case of a study property, when the free definition specification bit is 1, it can be defined freely using the area of b2-b0. Here, in the former, further the area of b2-b0 can be used as a place number. When the same kinds of spaces exist, the place numbers are used as numbers to distinguish them. For example, when two toilets exist, the place number of a toilet on the first floor is numbered as 001b and the place number of a toilet on the second floor is numbered as 010b, thereby being able to distinguish the two toilets from each other.

FIGS. 7A and 7B are explanatory views of an example of Bluetooth apparatus retrieval results within a building. FIG. 7A shows the conventional Bluetooth apparatus list, while the Bluetooth apparatus name of the wireless apparatus is “BT_Divice”. This “BT_Divice”, specifically, provides the name of the same kinds of apparatuses such as air conditioners. This disables a user to judge where the respective apparatuses are installed. On the other hand, FIG. 7B provides the Bluetooth apparatus list of the embodiment, showing a state example where description from the above-mentioned installation place property is added to the Bluetooth apparatus name of the wireless apparatus “BT_Divice”. As shown by a dashed-line enclosure, the respective places of a living room, a kitchen, a toilet and (a certain) room are added.

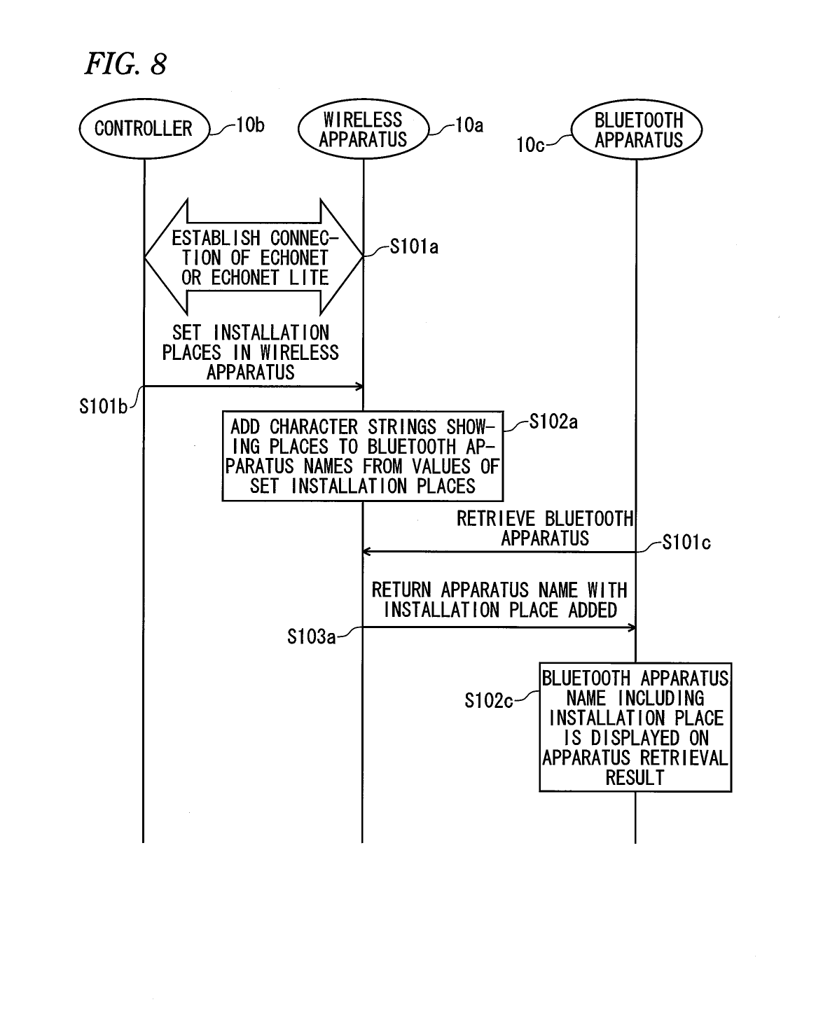

FIG. 8 is a flow chart of the communication of a controller with a wireless apparatus and a Bluetooth apparatus.

Firstly, a wireless apparatus (10a) and controller (10b) establish the connection of Echonet or Echonet Lite (S101a). In this case, the physical layer of Echonet or Echonet Lite may be any one of a wired LAN layer, a wireless LAN layer and a Bluetooth layer.

After this connection is established, the installation place of a wireless apparatus is set on the controller side (S101b). When the installation place is set from the controller, while referring to the value of the set installation place, the wireless apparatus selects a character string to be added to the Bluetooth apparatus name and adds a character string showing the installation place to the Bluetooth apparatus name (S102a).

Thereafter, when the Bluetooth apparatus (10c) performs apparatus retrieval, Name Request is transmitted to the wireless apparatus, whereby the wireless apparatus returns the Bluetooth apparatus name including the installation place to the Bluetooth apparatus (S103a).

When the Bluetooth apparatus retrieval is ended and the result is displayed, the character string including the installation place of the wireless apparatus is shown as the Bluetooth apparatus name of the wireless apparatus (S102c). Thus, for example, when a user wants to access a certain type of apparatus, the user can easily judge which one of apparatuses is installed in the target place. The Bluetooth connection can be established without confirming the Bluetooth address.

### Second Embodiment

Description is given of a second embodiment according to the invention. Description of parts used in common with the embodiment 1 is omitted. Description is given of a different method from the method for changing the apparatuses names as in the embodiment 1.

In the first embodiment, the pairing/connection is realized by adding the character string of the installation place to the Bluetooth apparatus name. However, in the Bluetooth ver2.1+EDR or higher, since data can be written into Extended Inquiry Response (ELR), by writing the value of an installation place property here, the pairing/connection can also be realized.

The Bluetooth communication module 116 having the wireless apparatus 10a is a communication portion for performing communication according to the Bluetooth standard, and the Bluetooth communication module 116 further includes, for example, a BR/EDR controller and an LE controller (neither of which is shown). That is, the wireless apparatus 10a is a so called dual mode device which supports both of BR/EDR and LE.

The BR/EDR controller is a communication controller which is operated according to the communication specifications (communication systems) of BR (Basic Rate) and EDR (Enhanced Data Rate). The LE controller is a communication controller to be operated according to the communication specifications (communication systems) of LE (Low Energy) to be specified by the Bluetooth v. 4.0.

The mobile phone 10c also has a similar structure to the wireless apparatus 10a, whereby the wireless apparatus 10a and mobile phone 10c can perform Bluetooth communication according to the BR/EDR, LE communication specifications (communication systems) (dual mode device).

Incidentally, an example of a processing sequence when the wireless apparatus 10a and mobile phone 10c establish connection according to the BR/EDR system is as follows.

Firstly, the mobile phone 10c serving as an apparatus to receive a connection request sets itself in Inquiry Scan (in a state where it can be detected) and is thus ready to be able to accept an apparatus detect request from other communication apparatus.

The wireless apparatus 10a, firstly, in order to confirm whether a detectable apparatus exists in the vicinity or not, transmits an apparatus detect request (packet) to the vicinity.

The mobile phone 10c set in Inquiry Scan (in a state where it can be detected), on receiving the apparatus detect request (packet), confirms the apparatus detect request (packet) and transmits an apparatus detect response (packet) to the wireless apparatus 10a. On transmitting the apparatus detect response (packet), the mobile phone 10 sets itself in Page Scan (in a state where it can be connected) and is thus ready to be able to accept a BR/EDR connection request from the wireless apparatus 10a.

On receiving the apparatus detect response from the mobile phone 10c, the wireless apparatus 10a, when it wants to start its connection with the mobile phone 10c, transmits a BR/EDR connection request to the mobile phone 10c.

On receiving the apparatus connection request from the wireless apparatus 10a, the mobile phone 10c transmits a BR/EDR connection response to the wireless apparatus 10a.

With the above sequence, the wireless apparatus 10a and mobile phone 10c can establish communication according to the BR/EDR system.

Now, description is given below of EIR and the like. As data, firstly, as apparatus information data which, as CPU 101 of FIG. 2 controls the main memory 103 to put apparatuses stored therein into operation, are transmitted from the apparatuses and are received by other apparatuses according to Inquiry, generally, there are available apparatus names and BD (Bluetooth Device) addresses. That is, information described in EIR to be transmitted includes apparatus names and BD addresses.

BD addresses are addresses used to distinguish apparatuses from each other when performing Bluetooth.

In the case of data to be written into Extended Inquiry Response, when, as an example of an associated data format, tags are put respectively before data main bodies, it is possible to confirm what the data within Extended Inquiry Response are.

Description is given again simply of Extended Inquiry Response. In Bluetooth, as a function to check what kinds of Bluetooth apparatuses exist within a radio wave reachable range, there is provided a function called Inquiry. In Inquiry, there is received apparatus information which is transmitted from Bluetooth apparatuses existing in the radio wave reachable range. At the then time, there is not yet established connection for transmission of the apparatus information. According to Core Specversion2.1, Inquiry is extended to Extended Inquiry Response which can transmit information up to 240 bytes as a whole besides the above apparatus information.

That is, EIR is information (information for establishment of wireless communication connection, information to be supplied for establishment of wireless communication connection) for establishment of wireless communication connection and, as the data format of EIR, there exist an area where data themselves are described and an area where the data lengths of the data are described. In the data described area, there exist an area for showing the tags of the data and an area where data shown by the tags are described.

Just before data about apparatus names, BD addresses and the like, there are applied tags to show that they are data about the apparatus names, BD addresses and the like.

### Third Embodiment

A third embodiment of the invention is described below. In this embodiment, description of some parts used in common with the embodiments 1 and 2 is omitted. Description is given of a still different method from the method for changing the apparatus names as in the embodiment 1.

That is, in Bluetooth ver 4.0, by writing the value of the installation place property into Scan Response Data, pairing/connection can also be realized.

The advertisement packet format of Bluetooth LE (BTLE) is constituted of 31 Octets of Advertising or Scan Response Data. The Significant part of such Data is constituted of multiple AD Structures. The AD Structure is constituted of 1 Octets of Length and Length Octets of Data. Such Data is constituted of n Octets of AD Types and Length-n Octets of AD Data. For example, Type, the allocation of AD Type value of which is 0x09, is Complete Local Name.

Conventionally, when the same products are installed, since they have the same Bluetooth apparatus name, it is difficult to confirm to which one of the Bluetooth apparatuses a wireless apparatus is connected. With this embodiment, for example, since places are added to the Bluetooth apparatuses names, while confirming to which one of the apparatuses the wireless apparatus is to be connected, Bluetooth connection can be realized, thereby being able to save labor for confirming the Bluetooth address. The controller and communication terminals refer to the properties of the communication protocols of higher-order layers and add them to the apparatus names of the communication protocols of lower-order layers.

For apparatuses respectively incorporating Echonet Lite and Bluetooth therein, for example, by adding information about their respective installation places to the Bluetooth apparatuses names, Bluetooth pairing/connection can be simplified. Especially, recently, HEMS corresponding apparatuses have increased. When multiple same products are installed within a building, they are displayed by the same apparatus name on the Bluetooth apparatus list and thus cannot be distinguished from each other. It takes labor to realize pairing/connection while confirming an apparatus to be connected. This embodiment can save such connection labor.

In summary, a wireless apparatus is connected to an apparatus operating as the controller of Echonet or Echonet Lite such as a tablet, a TV and a PC. Any one of wired LAN, wireless LAN and Bluetooth is used to make connection with Echonet or Echonet Lite. After such connection, the above installation place property is set on the controller side. While referring to the value of the installation place property of the wireless apparatus set on the controller side, for example, the character string of the installation place is added to the Bluetooth apparatus name of the wireless apparatus.

In the Bluetooth connection with the wireless apparatus, when retrieving apparatuses existing in the vicinity, Bluetooth apparatus names with the information about the installation places reflected thereon are displayed, which makes it possible to determine the place of the target Bluetooth apparatus.

That is, for problem solution, in this embodiment, the values of installation place properties essentially required in Echonet or Echonet Lite are set from the controller side and, based on the values, character strings representing the installation places are added, for example, to the Bluetooth apparatuses names. Thus, when retrieving the Bluetooth apparatus, the places of the apparatuses can be specified explicitly.

Here, the invention is not limited to the above embodiments but can also be enforced in various modifications without departing from the subject matter of the invention.

Also, when the multiple composing elements disclosed in the above embodiments are combined together properly, various inventions can also be made. For example, some composing elements can also be omitted from the whole composing elements disclosed in the embodiments. Further, the composing elements of different embodiments may also be combined properly.

1. A wireless apparatus with its installation place settable by a controller, comprising:
a receiver configured to receive the value of the set installation place from the controller;
a memory configured to the value of the installation place; and
a transmitter configured to the value of the installation place to a communication terminal.

2. A wireless apparatus according to claim 1, wherein
the memory stores the value of the installation place while adding the value to the apparatus name of the wireless apparatus.

3. A wireless apparatus according to claim 1, wherein
the memory stores the value of the installation place while adding the value to the Bluetooth apparatus name of the wireless apparatus.

4. A wireless apparatus according to claim 1, wherein
the memory stores the value of the installation place in Extended Inquiry Response.

5. A wireless apparatus according to claim 1, wherein
the memory stores the value of the installation place in Advertising Data or Scan Response Data.

6. A controller for setting the installation place of a wireless apparatus in the wireless apparatus, comprising:
an input module configured to input the setting of the installation place; and
a transmitter configured to add the value of the installation place to the apparatus name of the wireless apparatus and transmitting it to the wireless apparatus.
